(19) United States
(12) Patent Application Publication
(10) Pub. No.: US 2013/0201076 A1
(43) Pub. Date: Aug. 8, 2013

(54) ANTENNA INCLUDING AN ANTENNA BASE AND FEED LINE RETAINER AND ASSOCIATED METHODS

(71) Applicants: JOSHUA VOS, Melbourne, FL (US); Robert Corbit, Melbourne, FL (US); Gregory M. Jandzio, Melbourne, FL (US); Chris Snyder, Melbourne, FL (US); Thomas Reed, West Melbourne, FL (US)

(72) Inventors: JOSHUA VOS, Melbourne, FL (US); Robert Corbit, Melbourne, FL (US); Gregory M. Jandzio, Melbourne, FL (US); Chris Snyder, Melbourne, FL (US); Thomas Reed, West Melbourne, FL (US)

(73) Assignee: Harris Corporation, Corporation of the State of Delaware, Melbourne, FL (US)

(21) Appl. No.: 13/368,475

(22) Filed: Feb. 8, 2012

(51) Int. Cl. H01Q 21/00; H01P 11/00; H01Q 1/12

(52) U.S. Cl. 343/879; 343/878; 29/600

(57) ABSTRACT

An antenna includes an antenna base having a first optically cured resin body and a conductive layer thereon. In addition, the antenna also has at least one feed line constructed from an electrically conductive material. Moreover, a feed line retainer including a second optically cured resin body and having at least one recess therein carries the at least one feed line. The feed line retainer is positioned within the antenna base such that the at least one feed line does not contact the electrically conductive layer on the antenna base.

### FIELD OF THE INVENTION

The present invention relates to the field of wireless communications, and, more particularly, to antennas and related methods.

### BACKGROUND OF THE INVENTION

A phased array is an array of antennas in which the relative phases of the respective signals feeding the antennas are varied in such a way that the effective radiation pattern of the array is reinforced in a desired direction and suppressed in undesired directions. Relatively small phased array antennas constructed from small individual antenna elements are useful in a variety of aeronautical communications systems.

Multifunctional, one-dimensional multibeam phased arrays have been demonstrated, where beam control is obtained by implementing phase shifter or signal processing components as part of a hybrid circuit. To improve the overall gain and performance of the system, two-dimensional arrays have been formed. See, for example, the quasi-optical techniques described in Popovic et al., “Multibeam antennas with polarization and diversity,” IEEE Trans. Antennas Propagat., vol. 50, no. 5, pp. 651-657 (2002); and, Granholm et al., “Dual polarization stacked microstrip patch antenna array with very low cross-polarization,” IEEE Trans. Antennas Propagat., vol. 49, no. 10, pp. 1393-1402 (2001).

A typical drawback to these two-dimensional arrays is that, as the frequency range and/or bandwidth of the desired communications increases, the individual antennas of the array become more complex and more expensive to construct. One way to help construct complicated antenna elements while keeping costs reasonable is to form part of the antenna using three dimensional buildup techniques, such as selective laser sintering.

For example, another attempt at a two-dimensional array is described in U.S. Pat. No. 7,728,772 to Mortazawi et al. Mortazawi et al. discloses a dual polarized front-end device including a double-sided, tray-based waveguide structure that feeds an array of miniature horn antennas, forming a single aperture element. The waveguide structure is configured for operation at millimeter-wave frequencies via three dimensional fabrication techniques capable of forming three-dimensional structures with small shapes and complex angles. The three dimensional fabrication techniques involve a layer-by-layer fabrication process to form, for example, rigid polymer structures with near vertical sidewalls. The structures are then electroplated with metal to form double-sided trays for definition of separate sets of waveguide feeds dedicated to supporting control of multiple (e.g., orthogonal) polarizations.

Further advances in the fabrication of phased array antennas that allow the production of smaller features with tighter tolerances are, however, still needed.

### SUMMARY OF THE INVENTION

In view of the foregoing background, it is therefore an object of the present invention to provide an antenna that may be formed using processes that reduce production costs.

This and other objects, features, and advantages in accordance with the present invention are provided by an antenna that includes an antenna base comprising a first optically cured resin body with an electrically conductive layer thereon. The antenna also includes at least one feed line comprising an electrically conductive material. In addition, a feed line retainer comprises a second optically cured resin body that has at least one recess therein carrying the at least one feed line. The feed line retainer is positioned within the antenna base such that the at least one feed line does not contact the electrically conductive layer on the antenna base. The use of the optically cured resin bodies advantageously allows the antenna to be formed quickly and cheaply, and with complicated geometries, and it should be appreciated that this antenna may be used in a phased array.

In addition, the at least one feed line may comprise a pair of intersecting feed lines, and the at least one recess may comprise a pair of intersecting feed line recesses. Further, each feed line may comprise an elongate cross member and a pair of legs extending from opposite ends thereof.

A first feed line of the pair of intersecting feed lines may have an upward facing recess formed therein. Also, a second feed line of the pair of intersecting feed lines may have a downward facing recess formed therein receiving the upward facing recess of the first feed line. Moreover, the antenna base may comprise a skeletal bottom and a top thereon, the top including a plurality of outwardly extending panels.

A method aspect is directed to a method of forming an antenna. The method includes forming an antenna base comprising a first optically cured resin body, for example using stereolithography, and forming a conductive layer on the first optically cured resin body. The method also includes forming a feed line retainer comprising a second optically cured resin body and having at least one recess therein, for example using stereolithography. The method further includes forming at least one feed line comprising an electrically conductive material, and positioning the at least one feed line within the at least one recess. The method also includes positioning the feed line retainer within the antenna base such that the at least one feed line does not contact the electrically conductive layer on the antenna base.

### BRIEF DESCRIPTION OF THE DRAWINGS

FIG. 1 is a perspective view of an antenna according to the present invention.

FIG. 2 is a top view of the antenna of FIG. 1.

FIG. 3 is a bottom view of the antenna of FIG. 1.

FIG. 4 is a perspective view of the feed line retainer of the antenna of FIG. 1.

FIG. 5 is a perspective view of the feed line retainer of the antenna of FIG. 1 with the pair of intersecting feed lines installed therein.

FIG. 6 is a front view of a first feed line of the antenna of FIG. 1.

FIG. 7 is a front view of a second feed line of the antenna of FIG. 1.

FIG. 8 is a schematic view of a phased array including multiple antennas of the type shown in FIG. 1 according to the present invention.

FIG. 9 is a flowchart of a method of making an antenna according to the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

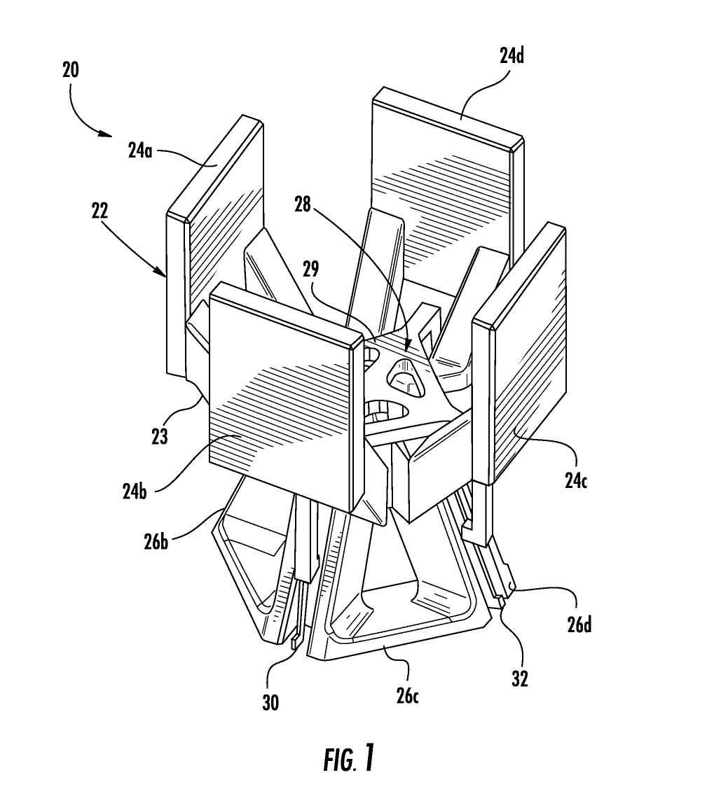

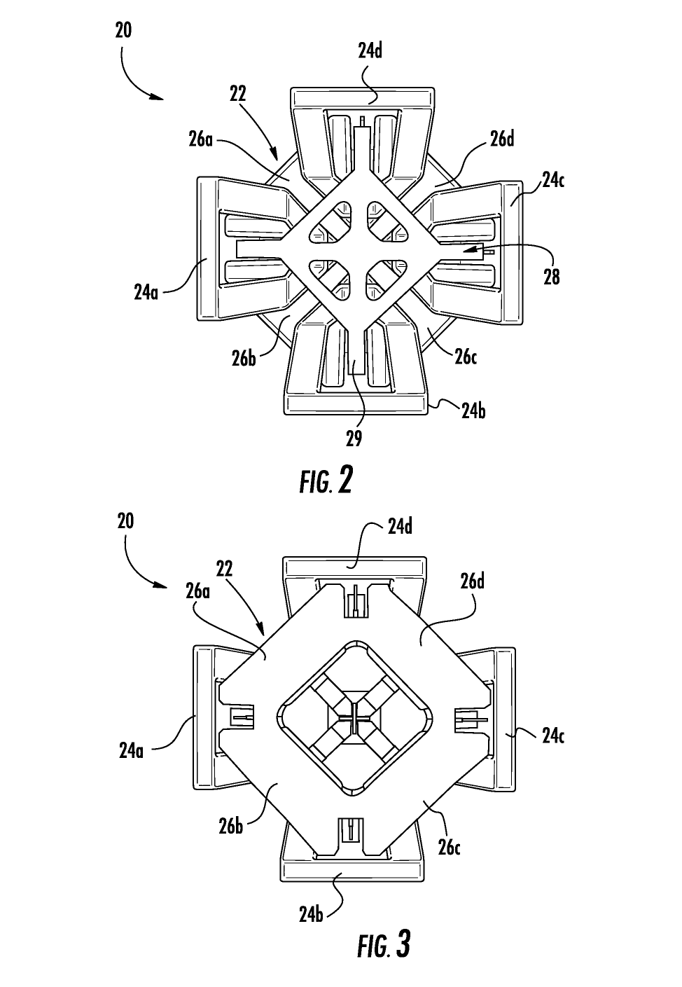

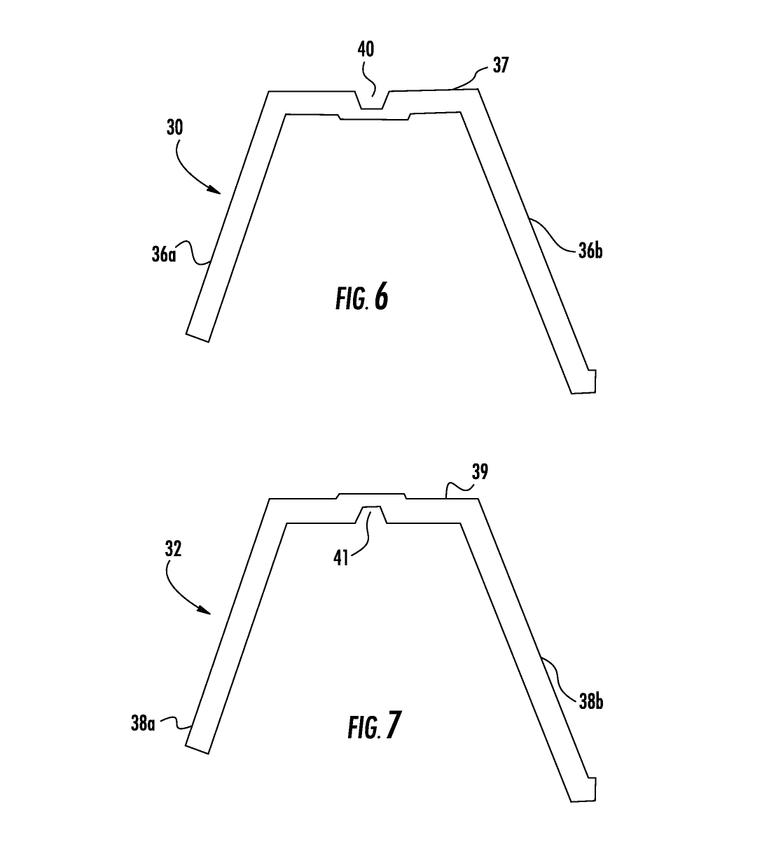

Referring initially to FIGS. 1-7, an antenna 20 comprises an antenna base 22 with a feed line retainer 28 held thereby, which in turns holds a pair of intersecting feed lines 30, 32. The antenna base 22 comprises a first optically cured resin body 23 with a conductive layer thereon. As will be explained in detail below, the optically cured resin body 23 of formed using build up techniques, such as stereolithography, selective laser sintering, and fused deposition modeling, for example, and then plated with a conductive material so that the electrically conductive layer is formed thereon.

The feed line retainer 28 similarly includes a second optically formed resin body 29 formed using build up techniques, such as stereolithography, selective laser sintering, and fused deposition modeling, for example, although it should be appreciated that it is not plated with a conductive material. Thus, the feed line retainer 28 is a nonconductive component. The pair of feed lines 30, 32 may be formed from an electrically conductive material by photochemical etching techniques.

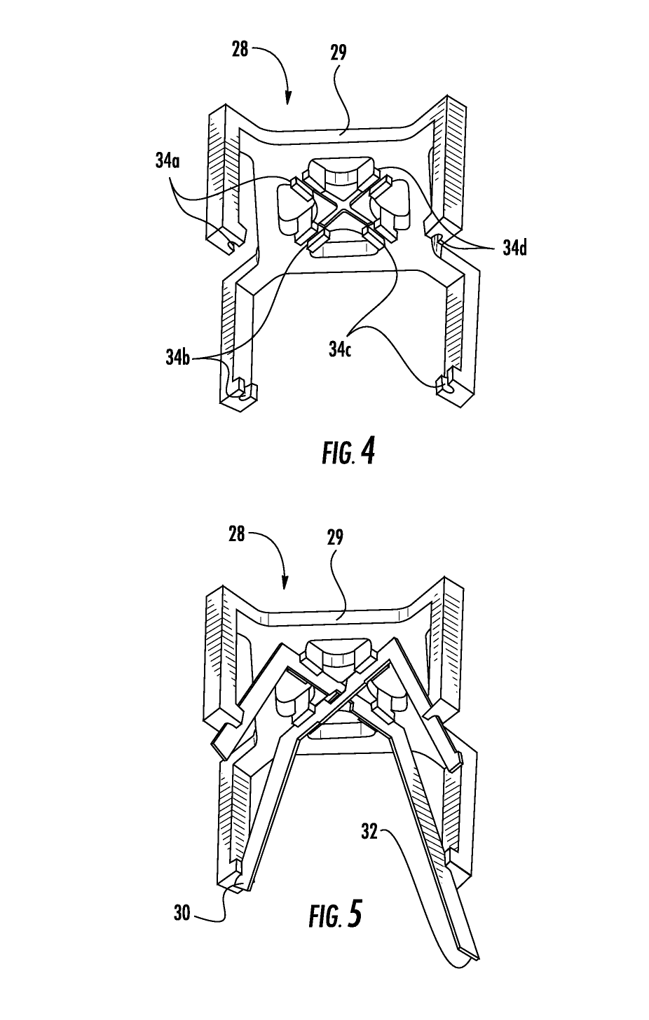

As perhaps best shown in FIG. 4 the feed line retainer 29 has a plurality of intersecting feed line recesses 34a-34d therein carrying the pair of intersecting feed lines 30, 32. As stated above, the feed line retainer 29 is positioned within the antenna base 22 such that neither of the feed lines 30, 32 contacts the electrically conductive layer of the antenna base 22.

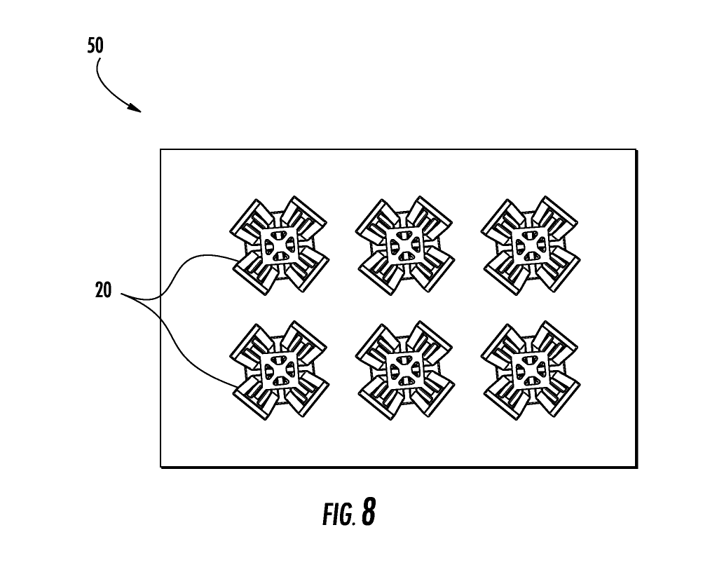

Each feed line 30, 32 illustratively comprises an elongate cross member 37, 39 with a pair of legs 36a-36b, 38a-38b extending from opposite ends thereof, as shown in FIGS. 6-7. The feed line 30 has an upward facing recess 40 formed therein. In addition, the feed line 32 has a downward facing recess 41 formed therein to receiving the upward facing recess 40 of the feed line 30 when installed in the feed line retainer 28 such that the two feed lines intersect and are electrically isolated from each other.

The antenna base 22 comprises a skeletal bottom 26a-26d with a top thereon. The top comprises a plurality of outwardly extending panels 24a-24d. The antenna base 22 is to be coupled to ground, while the pair of intersecting feed lines 30, 32 is to be coupled to signal feed points.

It should be appreciated that other embodiments are contemplated. For example, the antenna base 22 may have only two outwardly extending panels 24a-24b, and nonintersecting feed line recesses 34a-34b to receive a single antenna feed line 30.

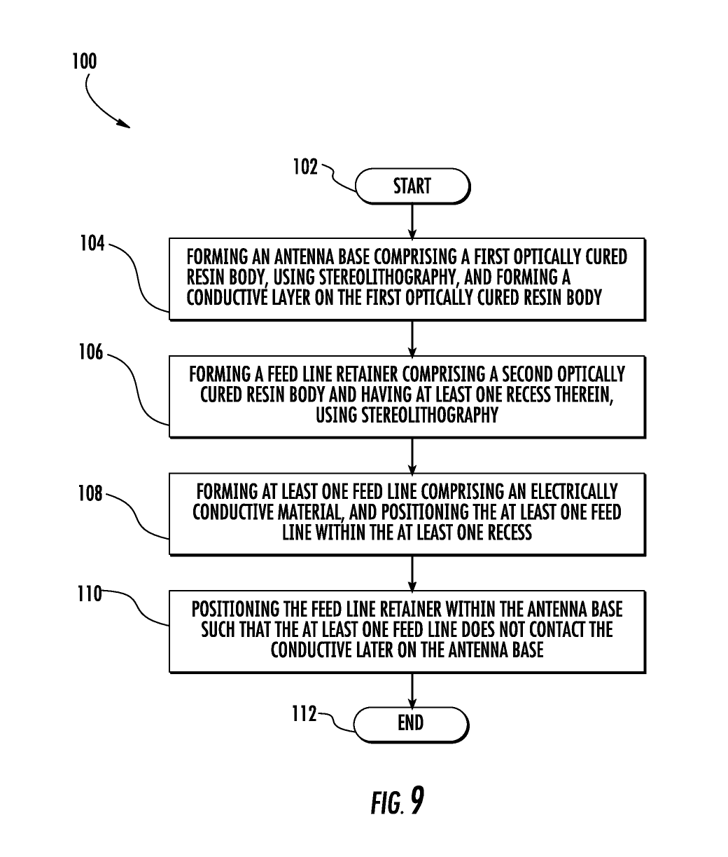

In some applications, multiple antennas 20 are intended to be used to construct a phased array 50, as shown in FIG. 8. As understood by those skilled in the art, a phased array 50 is an array of antennas in which the relative phases of the respective signals feeding the antennas 20 are varied in such a way that the effective radiation pattern of the array is reinforced in a desired direction and suppressed in undesired direction. These phased arrays 50 are particularly helpful for use on aircraft, for example. Since the panels 24a-24d are capacitively coupled to each other, the panels of adjacent antennas 20 of the phased array 50 help to increase the bandwidth of the phased array 50.

With reference to the flowchart 100 of FIG. 9, a method of forming an antenna is now described. After the start (102), the method includes forming an antenna base comprising a first optically cured resin body, and forming a conductive layer on the first optically cured resin body (Block 104). Next, the method includes forming a feed line retainer comprising a second optically cured resin body and having at least one recess therein (Block 106).

Proceeding further, the method then includes forming at least one feed line comprising an electrically conductive material, and positioning the at least one feed line within the at least one recess (Block 108). Still further, the method includes positioning the feed line retainer within the antenna base such that the at least one feed line does not contact the electrically conductive layer on the antenna base (Block 110). Block 112 indicates the end of the method.

As known to those skilled in the art, stereolithography is an additive manufacturing process using a vat of liquid UV-curable photopolymer resin and a UV laser that is used to build parts a layer at a time. On each layer, the laser beam traces a part cross-section pattern on the surface of the liquid resin. Exposure to the UV laser light cures, solidifies the pattern traced on the resin, and adheres it to the layer below.

The use of stereolithography to form components such as the antenna body 22 and feed line retainer 28 is particularly advantageous because it allows the use of a single process, as described above. In addition, stereolithgraphy allows the manufacture of antenna parts having complex geometries at a relatively low cost, and indeed allows the manufacture of complex geometries that may not be possible with other manufacturing techniques. Further, standard plating techniques may be used to form the electrically conductive layer of the antenna body 22. Moreover, testing has found that parts formed using stereolithography meets current NASA outgassing requirements.

Still further, individual components formed using stereolithography are compatible with current automated assembly techniques. Also, forming the antenna body 22 and feed line retainer 28 using stereolithography provides for scalable parts, allowing the production of antennas 20 that have satisfactory performance up to at least 20 GHz.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An antenna comprising:
an antenna base comprising a first optically cured resin body and an electrically conductive layer thereon;
at least one feed line comprising an electrically conductive material; and
a feed line retainer comprising a second optically cured resin body and having at least one recess therein carrying said at least one feed line, said feed line retainer positioned within said antenna base such that said at least one feed line does not contact said electrically conductive layer on said antenna base.

2. The antenna of claim 1, wherein said at least one feed line comprises a pair of intersecting feed lines; and wherein the at least one recess comprises a pair of intersecting feed line recesses.

3. The antenna of claim 2, wherein each feed line comprises an elongate cross member and a pair of legs extending from opposite ends thereof.

4. The antenna of claim 3, wherein a first feed line of said pair of intersecting feed lines has an upward facing recess formed therein; wherein a second feed line of said pair of intersecting feed lines has an downward facing recess formed therein receiving the upward facing recess of said first feed line.

5. The antenna of claim 1, wherein said antenna base comprises a skeletal bottom and a top thereon, the top comprising a plurality of outwardly extending panels.

6. An antenna array comprising:
a mounting substrate; and
a plurality of antennas on said mounting substrate, each antenna comprising
an antenna base comprising a first optically cured resin body and a conductive layer thereon,
at least one feed line comprising an electrically conductive material, and
a feed line retainer comprising a second optically cured resin body and having at least one recess therein carrying said at least one feed line, said feed line retainer positioned within said antenna base such that said at least one feed line does not contact said conductive layer on said antenna base.

7. The antenna array of claim 6, wherein said at least one feed line comprises a pair of intersecting feed lines; and wherein the at least one recess comprises a pair of intersecting feed line recesses.

8. The antenna array of claim 7, wherein each feed line comprises an elongate cross member and a pair of legs extending from opposite ends thereof.

9. The antenna array of claim 8, wherein a first feed line of said pair of intersecting feed lines has an upward facing recess formed therein; wherein a second feed line of said pair of intersecting feed lines has an downward facing recess formed therein receiving the upward facing recess of said first feed line.

10. The antenna array of claim 6, wherein said first optically cured resin body comprises a skeletal bottom and a top thereon, the top comprising a plurality of outwardly extending panels.

11. A method of forming an antenna comprising:
forming an antenna base comprising a first optically cured resin body, and forming an electrically conductive layer on the first optically cured resin body;
forming a feed line retainer comprising a second optically cured resin body and having at least one recess therein;
forming at least one feed line comprising an electrically conductive material, and positioning the at least one feed line within the at least one recess; and
positioning the feed line retainer within the antenna base such that the at least one feed line does not contact the electrically conductive layer on the antenna base.

12. The method of claim 11, wherein the at least one recess is formed as a pair of intersecting feed line recesses; and wherein the at least one feed line is formed as a pair of intersecting feed lines.

13. The method of claim 12, wherein each feed line is formed as an elongate cross member and a pair of legs extending from opposite ends thereof.

14. The method of claim 13, wherein a first feed line of the pair of intersecting feed lines is formed to have an upward facing slot formed therein;
wherein a second feed line of the pair of intersecting feed lines is formed to have an downward facing slot formed therein receiving the upward facing lot of the first feed line.

15. The method of claim 11, wherein the first optically cured resin body is formed to have a skeletal bottom and a top thereon, the top comprising a plurality of outwardly extending panels.

16. The method of claim 11, wherein the antenna base is formed using at least one of stereolithography, selective laser sintering, and fused deposition modeling.

17. The method of claim 11, wherein the feed line retainer is formed using at least one of stereolithography, selective laser sintering, and fused deposition modeling.

18. A method of forming an antenna array comprising:
forming a plurality of antennas on a mounting substrate, each antenna being formed by
forming an antenna base comprising a first optically cured resin body, and forming an electrically conductive layer on the first optically cured resin body,
forming a feed line retainer comprising a second optically cured resin body and having at least one recess therein,
forming at least one feed line comprising an electrically conductive material, and positioning the at least one feed line within the at least one recess, and
positioning the feed line retainer within the antenna base such that the at least one feed line does not contact the electrically conductive layer on the antenna base.

19. The method of claim 18, wherein the at least one recess is formed as a pair of intersecting feed line recesses; and wherein the at least one feed line is formed as a pair of intersecting feed lines.

20. The method of claim 19, wherein each feed line is formed as an elongate cross member and a pair of legs extending from opposite ends thereof.

21. The method of claim 20, wherein a first feed line of the pair of intersecting feed lines is formed to have an upward facing recess formed therein; wherein a second feed line of the pair of intersecting feed lines is formed to have an downward facing recess formed therein receiving the upward facing recess of the first feed line.

22. The method of claim 18, wherein the first optically cured resin body is formed to have a skeletal bottom and a top thereon, the top comprising a plurality of outwardly extending panels.

23. The method of claim 18, wherein the first optically cured resin body is formed to have a skeletal bottom and a top thereon, the top comprising a plurality of outwardly extending panels.

24. The method of claim 18, wherein the antenna base is formed using at least one of stereolithography, selective laser sintering, and fused deposition modeling.
